(19) United States
(12) Patent Application Publication
(10) Pub. No.: US 2008/0243378 A1
(43) Pub. Date: Oct. 2, 2008

(54) SYSTEM AND METHOD FOR VEHICLE NAVIGATION AND PILOTING INCLUDING ABSOLUTE AND RELATIVE COORDINATES

(75) Inventor: Walter B. Zavoli, Palo Alto, CA (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/034,521

(22) Filed: Feb. 20, 2008

Related U.S. Application Data
(60) Provisional application No. 60/891,019, filed on Feb. 21, 2007.

(51) Int. Cl. G01C 21/26; G01C 21/00

(52) U.S. Cl. 701/209; 701/208

(57) ABSTRACT

A navigation system for use in a vehicle. The system includes an absolute position sensor, such as GPS, in addition to one or more additional sensors, such as a camera, laser scanner, or radar. The system further comprises a digital map or database that includes records for at least some of the vehicle's surrounding objects. These records can include relative positional attributes and traditional absolute positions. As the vehicle moves, sensors sense the presence of at least some of these objects, and measure the vehicle's relative position to those objects. This information, together with the absolute positional information and the added map information, is used to determine the vehicle's location, and support features such as enhanced driving directions, collision avoidance, or automatic assisted driving. In accordance with an embodiment, the system also allows some objects to be attributed using relative positioning, without recourse to storing absolute position information.

### CLAIM OF PRIORITY

This application claims the benefit of U.S. Provisional Patent Application titled “SYSTEM AND METHOD FOR VEHICLE NAVIGATION AND PILOTING INCLUDING ABSOLUTE AND RELATIVE COORDINATES”; Application No. 60/891,019; inventor Walter B. Zavoli; filed Feb. 21, 2007, and herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to digital maps, geographical positioning systems, and vehicle navigation, and particularly to a system and method for vehicle navigation and piloting using absolute and relative coordinates.

### BACKGROUND

Within the past several years, navigation systems, electronic maps (also referred to herein as digital maps), and geographical positioning devices, have been increasingly used in vehicles to assist the driver with various navigation functions. Examples of such navigation functions include determining the overall position and orientation of the vehicle; finding destinations and addresses; calculating optimal routes; and providing real-time driving guidance, including access to business listings or yellow pages. Typically the navigation system portrays a network of streets as a series of line segments, including a centerline running approximately along the center of each street. The moving vehicle can then be generally located on the map close to or with regard to that centerline.

Some early vehicle navigation systems, such as those described in U.S. Pat. No. 4,796,191, rely primarily on relative-position determination sensors, together with a “dead-reckoning” feature, to estimate the current location and heading of the vehicle. This technique is prone to accumulating small amounts of positional error, which can be partially corrected with “map matching” algorithms. The map matching algorithm compares the dead-reckoned position calculated by the vehicle's computer with a digital map of streets, to find the most appropriate point on the street network of the map, if such a point can indeed be found. The system then updates the vehicle's dead-reckoned position to match the presumably more accurate “updated position” on the map.

With the introduction of reasonably-priced Geographical Positioning System (GPS) satellite receiver hardware, a GPS receiver or GPS unit can be added to the navigation system to receive a satellite signal and to use that signal to directly compute the absolute position of the vehicle. However, map matching is still typically used to eliminate errors within the GPS receiver and within the map, and to more accurately show the driver where he is on that map. Even though on a global or macro-scale satellite technology is extremely accurate; on a local or micro-scale small positional errors still do exist. This is primarily because the GPS receiver can experience an intermittent or poor signal reception, and also because both the centerline representation of the streets and the measured position from the GPS receiver may only be accurate to within several meters. Higher performing systems use a combination of dead-reckoning and GPS to reduce position determination errors, but even with this combination, errors can still occur at levels of several meters or more. Inertial sensors can be added to provide a benefit over moderate distances, but over larger distances even systems with inertial sensors accumulate error.

However, while vehicle navigation devices have gradually improved over time, becoming more accurate, feature-rich, cheaper, and popular; they still fall behind the increasing demands of the automobile industry. In particular, it is expected that future applications will require higher positional accuracy, and even more detailed, accurate, and feature-rich maps. Within this context, the accuracy within the current generation of consumer navigation systems, on the order of 5 to 10 meters, is simply not adequate, and systems that are many times more accurate are needed. However, to date, no convenient solution has been found.

### SUMMARY OF THE INVENTION

Disclosed herein is a navigation system for use in a vehicle. The navigation system includes an absolute position sensor, such as GPS, in addition to one or more additional sensors, such as a camera, laser scanner, or radar. The navigation system further comprises a digital map or database, that includes records for at least some of the vehicle's surrounding objects, including lane markers, street signs, and buildings, in addition to traditional information such as street centerlines, street names and addresses. These records include relative positional attributes in addition to the traditional absolute positions. As the vehicle is moving, the additional sensors can sense the presence of at least some of these objects, and can measure the vehicle's relative position to those objects. This sensor information, together with the absolute positional information and the added map information, is then used to determine the vehicle's accurate location, and if necessary to support features such as enhanced driving directions or collision avoidance, or even computer assisted driving or piloting. In accordance with an embodiment, the system also allows some objects to be attributed using relative positioning, without recourse to storing absolute position information.

### BRIEF DESCRIPTION OF THE FIGURES

FIG. 1 shows an illustration of an environment that can use vehicle navigation using absolute and relative coordinates, in accordance with an embodiment of the invention.

FIG. 2 shows an illustration of a system for vehicle navigation using absolute and relative coordinates, in accordance with an embodiment of the invention.

FIG. 3 shows an illustration of a database of map information, including absolute and relative coordinates, in accordance with an embodiment of the invention.

FIG. 4 shows a flowchart of a method for navigating using absolute and relative coordinates, in accordance with an embodiment of the invention.

FIG. 5 shows another flowchart of a method for navigating using absolute and relative coordinates, in accordance with an embodiment of the invention.

FIG. 6 shows a more-detailed illustration of an environment that uses a vehicle navigation system and method, in accordance with an embodiment of the invention.

FIG. 7 shows another flowchart of a method for navigating using absolute and relative coordinates, in accordance with an embodiment of the invention.

FIG. 8 shows an illustration of an environment that can use vehicle navigation to discern lane positioning, in accordance with an embodiment of the invention.

FIG. 9 shows an illustration of an environment that can use vehicle navigation to discern lane positioning, in accordance with an embodiment of the invention.

FIG. 10 shows an illustration of an environment that can use vehicle navigation to discern lane positioning, in accordance with an embodiment of the invention.

### DETAILED DESCRIPTION

Within the past several years, navigation systems, electronic maps (also referred to herein as digital maps), and geographical positioning devices, have been increasingly used in vehicles to assist the driver with various navigation functions. Examples of such navigation functions include determining the overall position and orientation of the vehicle; finding destinations and addresses; calculating optimal routes (perhaps with the assistance of realtime traffic information); and providing real-time driving guidance, including access to business listings or yellow pages. Typically the navigation system portrays a network of streets as a series of line segments, including a centerline running approximately along the center of each street. The moving vehicle can then be generally located on the map close to or co-located with regard to that centerline.

Some early vehicle navigation systems relied primarily on relative-position determination sensors, together with a “dead-reckoning” feature, to estimate the current location and heading of the vehicle. This technique is prone to accumulating small amounts of positional error, which can be partially corrected with “map matching” algorithms. The map matching algorithm compares the dead-reckoned position calculated by the vehicle's computer with a digital map of street centerlines, to find the most appropriate point on the street network of the map, if such a point can indeed be found. The system then updates the vehicle's dead-reckoned position to match the presumably more accurate “updated position” on the map.

With the introduction of reasonably-priced Geographical Positioning System (GPS) satellite receiver hardware, a GPS receiver or GPS unit can be added to the navigation system to receive a satellite signal and to use that signal to directly compute the absolute position of the vehicle. However, map matching is still typically used to eliminate errors within the GPS system and within the map, and to more accurately show the driver where he/she is on (or relative to) that map. Even though on a global or macro-scale, satellite technology is extremely accurate; on a local or micro-scale small positional errors still do exist. This is primarily because the GPS receiver can experience an intermittent or poor signal reception or signal multipath, and also because both the centerline representation of the streets and the actual position of the GPS system may only be accurate to within several meters. Higher performing systems use a combination of dead-reckoning(DR)/inertial navigation systems (INS) and GPS to reduce position determination errors, but even with this combination errors can still occur at levels of several meters or more. Inertial sensors can provide a benefit over moderate distances, but over larger distances even systems with inertial sensors accumulate error.

### Introduction

While vehicle navigation devices have gradually improved over time, becoming more accurate, feature-rich, cheaper, and popular; they still fall behind the increasing demands of the automobile industry. In particular, it is expected that future vehicle navigation applications that require higher positional accuracy, and even more detailed, accurate, and feature-rich maps. Examples of these applications include:
Adding more precise navigation guidance features to vehicles, that can be supported by improved mapping capabilities, and provide better usability and convenience for the driver.
Adding various safety applications, such as collision avoidance, which may, in turn, depend on having accurate knowledge of the position and heading of the vehicle relative to other nearby moving and stationary objects, including other vehicles.

Within this context, the accuracy within the current generation of consumer navigation systems, on the order of 5 to 10 meters, is simply not adequate, and systems that are many times more accurate are needed. In order to meet these future needs, the automobile industry is looking at ways to improve both the accuracy of digital maps and the accuracy of on-board position determination (e.g. GPS, etc.) sensors.

For example, the automobile industry is now developing low-cost and high-performance object detection sensors that can sense the existence, position and bearing to objects within the vicinity of a moving automobile that it is installed in. Such sensors include cameras (both video and still cameras), radar and laser scanners, and other types of sensors. Examples of these sensors have been used in parking assistance (i.e. distance) sensors for a number of years. The industry has also expressed an interest in automatic real-time object recognition, which could be used to distinguish lane dividers, or other vehicles; and the use of additional roadside equipment, say at important intersections, that could communicate with cars in the immediate vicinity so as to augment their position determination capabilities.

At the same time, the digital mapping industry, including companies such as Tele Atlas, is putting greater amounts of information into its digital maps. This increased information is being combined with much higher accuracy so as to better support advanced future applications. Examples of the features now included in digital maps include: the accurate representation of the number of lanes within a particular street or road; the positions of those lanes and barriers; the identification and location of objects such as street signs and buildings footprints; and the inclusion of objects within a rich three-dimensional (3D) representation that portrays actual building facades and other features.

To date, the emphasis in specifying greater accuracies has been on the basis of improving absolute accuracy, i.e. improving the system's knowledge of the absolute position of an object on the surface of the earth, as represented by an appropriate coordinate referencing system such as latitude-longitude. But the improvements required both in the navigation systems' absolute accuracy measurements, and in the collection of all map object information to such a high level of absolute accuracy would be hugely expensive to achieve. Alternative systems such as the collection of probe data from many cars and subsequent analysis and processing has been proposed but is till very much in the R&D phase. As such, no commercially practical system has been developed to date. Furthermore, while such communication of absolute measurements would be sufficient to provide the information suitable for use in collision avoidance and other new and demanding applications, it is not necessary. Under normal driving circumstances, a driver avoids collisions and makes detailed lane adjustments (i.e. safely “pilots” the vehicle) because he/she is aware of the relative distance and orientation between their car and another vehicle, or another object nearby. With regard to collision avoidance the driver can determine if he/she is going to approach the other object too closely. As such, drivers do not use absolute location measurements at all. This would suggest that, to provide a measure of safer driving or collision avoidance, relative measurements alone may be sufficient. However, in a vehicle with a navigation system, it is likely that some determination of absolute position must be made, at least initially, so that the system can match its position to the map with nominal accuracy and thereby access necessary information, such as routing information and the like, which it can then use to determine which particular relative measurements to make.

It is one aspect of the present invention to make a system that supports some or all of the advanced features mentioned above yet requires only nominal absolute accuracy, including accuracies that are readily achievable with today's systems. The key then is the addition of attribute data on map database objects that include relative position coordinates having high relative accuracy with respect to objects within its vicinity and the addition of sensor systems in the vehicle that can detect objects within its vicinity.

Embodiments of the present invention are designed to meet the advanced needs which the automobile industry is striving for; including much higher positional accuracies, both for on-board position determination equipment and for the digital map; but to do so in a manner that is more readily achievable. For example, to know which lane a vehicle is moving within requires a combined error budget of no more than 1 to 2 meters. Applications that use object avoidance (for example, to prevent collision with an oncoming car straying outside its lane), may require a combined error budget of less than 1 meter. Achieving this requires even smaller error tolerances in both the vehicle position determination, and in the map. It is one aspect of the present invention that absolute accuracies are not always required.

In accordance with another embodiment, the system is designed to use nominal absolute accuracies, in combination with higher relative accuracies, to achieve overall better accuracies, and to do so in an efficient manner. An object's position, with its higher relative accuracy, need only be loosely coupled to that same object's absolute position with its lower accuracy.

In accordance with another embodiment, the system comprises a digital map, or map database, which provides the relative positions of objects near each other at a higher relative accuracy; but as the distance between objects grows, the relative accuracy requirement between them diminishes. In this manner, as the vehicle approaches specific objects, and as accuracy becomes more important relevant to those objects, the information in the map database can be selectively retrieved, with increasing degrees of accuracy relative to those objects, to improve the vehicle's positional accuracy relative to those objects.

In accordance with another embodiment, the relative accuracies can be used to construct an optimized absolute accuracy of all objects, which can then be used to provide the navigation system with higher accuracy.

In accordance with another embodiment, the relative measurements can be used in combination with the absolute measurements to increase the vehicles absolute positional accuracy.

In accordance with another embodiment, since on-board sensors may not have a sufficient range or sensitivity to sense all objects in their local vicinity out to useful ranges and at all angles, the system allows accurate relative position information to be communicated between, say, two approaching objects, such as two vehicles.

In accordance with another embodiment, the system characterizes all of the objects in a map database, and all vehicles, in terms of very accurate absolute coordinates. Under these circumstances, vehicles can communicate their absolute coordinates and headings to each other. The system then uses algorithms to determine if collision avoidance measures or warnings need to be taken.

In accordance with another embodiment, a subset of all the objects in the map database are used as “position enabling” objects. Each ‘position enabling’ object carries, at a minimum, two sets of position coordinates. The first are its absolute coordinates referenced to any appropriate coordinate system, for example WGS-80 coordinates. The second are its relative coordinates referenced to any appropriate coordinate system, such as a local planar (for example, x,y,z) coordinate system. The two sets of position coordinates need only be connected by virtue of their linkage to the same underlying object in the database. In some instances, more than one set of relative coordinates can be used if the object has significantly different apparent locations as “seen” by different sensors (for example a laser scanner might measure a concrete pillar at one location, and a radar might measure the same concrete pillar at a slightly different location because each sensor type is measuring different reflectivity properties of the pillar).

In accordance with another embodiment, the object data in the map may, in addition to or instead of complete objects (such as the pillar in the previous paragraph), comprise raw sensor samples of the object from one or more sensor type.

In accordance with another embodiment, in addition to carrying both absolute and relative coordinates, the database can carry other useful information, such as the accuracy of its relative measurements, or the date the object was last measured, or flags indicating a crossing of a coordinate system boundary, or additional data defining the object, such as the wording on a particular sign or the name of a particular building etc.

In accordance with another embodiment, the navigation system can use the relative accuracy it calculates for the vehicle and surrounding objects to provide enhanced directional guidance.

In accordance with another embodiment the navigation system in the vehicle can use its relative position of sensor-detected objects, in combination with its absolute position and, under some circumstances, its heading estimate, to search and appropriate area (the search area) within the map database to find the set of objects that should contain the sensor detected objects. The navigation system can then use its position estimates and additional sensed characteristics of the sensed object to match against positions and characteristics found as object attributes in the map to identify the object in the map database that matches the sensed object.

In accordance with another embodiment the navigation system can use it's enhanced knowledge about the position of the vehicle to provide piloting assistance, including collision avoidance and other computer assisted piloting of the vehicle as necessary.

### Driving Environment

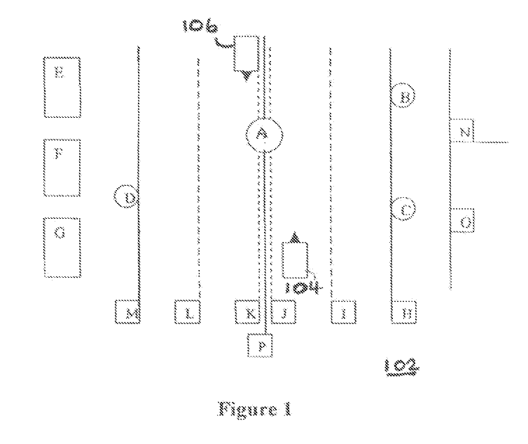

FIG. 1 shows an illustration of an environment 102 that can use vehicle navigation using absolute and relative coordinates, in accordance with an embodiment of the invention. FIG. 1 illustrates a typical street scene together with cars, lanes, road signs, objects and buildings. In accordance with an embodiment, the street information can be stored in a digital map, or map database, together with each of the stationary objects included as records in that database. Companies that provide digital maps are typically referred to as map providers.

As shown in FIG. 1, labels 1, J, K and L identify individual painted lines and other objects that might be found on the street. The solid line labeled P represents the single centerline representation of the road. Lines J and K are very close together, and represent the typical double-yellow marking or lines that one might find in the middle of a road. Lines I and L represent lane dividers, while lines H and M represent the street curbs. Labels E, F, G, N and O represent buildings; and labels A, B, C, and D represent street signs or notices, such as speed signs, stop signs, and street name signs.

As also shown in FIG. 1, label 104 represents a first vehicle (i.e. a car) traveling northbound on the street, while label 106 represents a second vehicle (i.e. another car) traveling southbound. FIG. 1 thus illustrates an example of a typical surface street with two lanes of traffic in each direction, and a number of cars traveling in those lanes.

In accordance with an embodiment, each vehicle can include a navigation device, which in turn includes an absolute location determination device such as a GPS receiver to determine the vehicle's (initial) absolute position. The navigation device may include inertial or dead reckoning sensors to be used in conjunction with the GPS device, to improve this estimated position, and to continue providing good estimates of position even when the GPS unit momentarily loses satellite reception. The navigation device in each vehicle can also include a map database and a map matching algorithm.

The map databases that are commonly used in navigation systems of today do not include references for all the features shown in FIG. 1. Instead, most contemporary map databases store a single line object to reference a road, identified in FIG. 1 as the line P depicting the centerline. It will be noted that this is a non-physical feature, and there may or may not be an actual painted stripe marking this center. Today's navigation systems have sufficient accuracy and map detail to allow the onboard position determination to match the vehicle's position to the appropriate street centerline, and thereby show the vehicle on the proper place in relation to a centerline map. From there the system can help the driver with orientation, routing and guidance functions.

However, this level of precision is insufficient both in detail and in accuracy to tell the driver what driving lane he/she may be in (and thereby give more detailed driving guidance), or to warn the driver that he/she may be in danger of a collision. In fact, in today's mapping systems the majority of non-highway roads are depicted on the map with a single centerline which is used for vehicles traveling in both directions. Using contemporary map matching techniques, the vehicles appear to be traveling along the same line, and thus if viewed in relation to each other would always appear to be in danger of collision. Alternatively, for those digital maps in which roads are represented on the map by a center line in each direction, the cars traveling in each direction would match to the appropriately oriented element of that road segment pair, and the cars, if viewed in relation to each other, would never appear to be in a position to collide, even if in reality the situation was quite different.

In accordance with an embodiment, the digital map or map database is configured to contain more information about the objects in the vehicle's surrounding environment. Similarly, the vehicles contain sensors which assist in determining a more accurate position. The navigation system then combines information from digital map, and vehicle sensors to determine a more accurate position for the vehicle on the road. The combination of these features makes features such as navigation, and collision warning, much more useable.

When these features are applied to the example environment shown in FIG. 1, then in accordance with an embodiment each vehicle includes a navigation system. In addition to any absolute position determination equipment (such as GPS), each vehicle also includes one or more additional sensors, such as a camera, laser scanner, or radar. The navigation system in the vehicle further comprises a digital map or digital map database that includes at least some of the surrounding objects, such as the objects labeled with letters A through O. In accordance with an embodiment, the additional sensor can sense the presence of at least some of these objects, and can measure its relative position (distance and bearing) to those objects. This sensor information, together with the absolute information, is then used to determine the vehicle's accurate location, and if necessary to support features such as assisted driving or collision avoidance.

### Automatic (Assisted) Driving and Collision Avoidance

In order to illustrate the use of the navigation system for automatic/assisted driving or collision avoidance, three examples are provided below. It will be evident that, while embodiments of the invention are described primarily with regard to collision avoidance, this is just one example of the usage to which the navigation can be applied, and that there are many other applications, including accurate route guidance, improved position determination, and access to more useful or localized map information. It will also be evident that when used for collision avoidance, route finding, and other applications, while in many instances the feedback to the vehicle or driver may be a warning, such as that a collision is about to take place, in other instances the feedback may be an instruction to the vehicle to take procedures, such as steering, or braking, to follow the chosen route or to avoid the collision.

### EXAMPLE 1

### Vehicles within Direct Sensor Range of Each Other

In this example, the sensor within each vehicle can identify the other vehicle, and can estimate its distance and bearing. The navigation or collision avoidance system can judge if it is closing in such a way that there is a possibility of collision. In this example the digital map is not really needed although a digital map is useful to give some context to the situation (for example a bend in the road might help to explain why two vehicles are on an apparent collision path, but that it should be anticipated that the vehicles will soon turn away from one another). In this direct sensor case the vehicle sensors themselves use relative measurements to make these observations. This case also applies to the sensing of stationary objects. Again, no digital map is needed to sense a stationary object, but it is helpful to map match to the objects in a map to both identify the objects in relationship to the road geometry, and also to obtain additional information about the objects.

Depending upon the accuracy of the sensor, it is easy to identify, for example, a road sign and estimate its relative position to an accuracy of just a few centimeters relative to the vehicle's position (which may have an estimated absolute positional accuracy of a few meters). With today's mapping accuracies, the same sign can be attributed in the database with a position having an absolute accuracy also on the order of a few meters. Thus the map matching problem becomes one of unambiguously identifying the object in the database with the appropriate characteristics within a search radius of, for example, 10 meters around the vehicle.

### EXAMPLE 2

### Vehicles within Sensor Range of the Same Object

In this example, the sensors on board each vehicle may not have a sufficient range or sensitivity to detect the other vehicle directly. Perhaps there are obstructions such as a hill blocking direct sensor detection. However each sensor in a vehicle can detect a common object, such as the sign A in FIG. 1. As in the example described above, each vehicle can use “object-based map matching” to match to the sign A using the nominal accuracies of today's absolute position determinations both on board the vehicle and within the map. Unlike the typical “map matching” feature mentioned above as part of today's navigation systems, which matches the estimated position of the vehicle against road centerlines contained in the map; in accordance with an embodiment of the invention, object-based map matching matches the estimated position and characteristics of physical objects sensed by the vehicle against one or more physical objects and their characteristics represented in the map to unambiguously match to the same object. Coupled with its heading estimate, each vehicle then can compute a more accurate relative position (within centimeters) with respect to sign A. This information is then used, perhaps along with other information such as its velocity, to compute trajectories with sufficient accuracy to estimate a possible collision. In a system with communications means between the vehicles, communication of a common map object identification and relative position and heading referenced from this common map object provides the accuracy necessary to allow for reliable detection of possible collisions with adequately small false alarms. All that is needed is a common map object identification scheme and a common local relative coordinate system.

It will be noted that in the above example, the common object used to determine position was identified and matched by using today's position determination technology (i.e. absolute positioning), along with the current inventions idea of object-based map matching, but that the actual collision warning was computed with the aid of sensor measurements using only relative position referencing.

It will also be noted that the common object identification can be further insured by installing radio frequency identification (RFID) tags, or similar tags, on objects, as has been widely proposed. Each vehicle can then sense the RFID tag on the object, and can use this identifier as a further means to minimize the error involved in identifying a common object.

### EXAMPLE 3

### Vehicles Beyond the Sensor Range of the Same Object

In the most general case, the sensors on board the two vehicles may not be able to detect the other vehicle, or a common object, but may still be able to detect objects in their immediate vicinity. For example, there may be no convenient object such as the sign A in FIG. 1 that happens to be between the two vehicles and visible to both vehicles. Instead, vehicle 104 may only be able to detect signs B and C; and vehicle 106 may only be able to detect sign D. Even so, vehicle 104 can obtain a very accurate relative position and heading based on its relative sensor measurements from objects B and C. Similarly, vehicle 106 can obtain a very accurate relative position and heading from its measurements of object D and its heading estimate. Because B and C and D all have accurate relative positions to each other as stored in the map databases, these accurate relative positions can then be used by the vehicles for improve driving, route guidance, and collision avoidance. As long as the vehicles use the same standard relative coordinate system they can again communicate accurate position, heading and speed information to each other for calculating trajectories and possible collisions.

### Navigation System

In accordance with an embodiment, an important aspect of the invention is that the objects in the digital map, for example the signs B, C and D have an accurate relative measurements to one another. This can be facilitated by placing them accurately on a common relative coordinate system (i.e. by giving them relative coordinates from a common system), and then storing information about those coordinates in the digital map, for subsequent retrieval by a vehicle with such a map and system, while the system is moving. In this example, vehicle 104 can then determine its position and heading accurately on this relative coordinate system; while vehicle 106 can do the same. When a communications means is included in the navigation system, the vehicles can exchange data and can accurately determine if there is a likelihood of collision. Alternatively, the data can be fed to a centralized or distributed off-board processor for computations and the results then sent down to the vehicle or used to adjust infrastructure such as vehicle speed limits, or warning lights or stop lights.

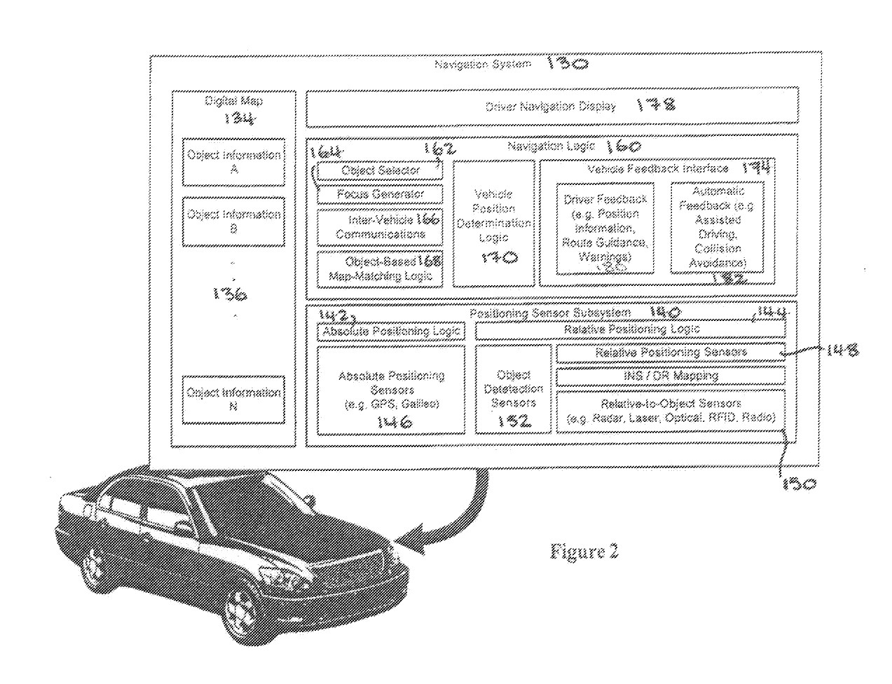

FIG. 2 shows an illustration of a system for vehicle navigation using absolute and relative coordinates, in accordance with an embodiment of the invention. As shown in FIG. 2, the system comprises a navigation system 130 that can be placed in a vehicle, such as a car, truck, bus, or any other moving vehicle. Alternative embodiments can be similarly designed for use in shipping, aviation, handheld navigation devices, and other activities and uses. The navigation system comprises a digital map or map database 134, which in turn includes a plurality of object information 136. In accordance with an embodiment, some or all of the object records includes information about the absolute and the relative position of the object (or raw sensor samples from objects). The digital map feature and the use of relative positioning of objects is described in further detail below.

The navigation system further comprises a positioning sensor subsystem 140. In accordance with an embodiment, the positioning sensor subsystem includes a mix of one or more absolute positioning logics 142 and relative positioning logics 144. The absolute positioning logic obtains data from absolute positioning sensors 146, including or example GPS or Galileo receivers. This data can be used to obtain an initial estimate as to the absolute position of the vehicle. The relative positioning logic obtains data from relative positioning sensors 148, including for example radar, laser, optical (visible), RFID, or radio sensors 150. This data can be used to obtain an estimate as to the relative position or bearing of the vehicle compared to an object. The object may be known to the system (in which case the digital map will include a record for that object), or unknown (in which case the digital map will not include a record).

The navigation further comprises a navigation logic 160. In accordance with an embodiment, the navigation logic includes a number of additional components, such as those shown in FIG. 2. It will be evident that some of the components are optional, and that other components may be added as necessary. An object selector 162 can be included to select or to match which objects are to be retrieved from the digital map or map database and used to calculate a relative position for the vehicle. A focus generator 164 can be included to determine a search area or region around the vehicle centered approximately on the initial absolute position. During use, an object-based map match is performed to identify the appropriate object or objects within that search area, and the information about those objects can then be retrieved from the digital map. As described above, a communications logic 166 can be included to communicate information from the navigation system in one vehicle to that of another vehicle directly or via some form of supporting infrastructure. An object-based map matching logic 168 can be included to match sensor detected objects and their attributes, to known map features (and their attributes), such as street signs, and other known reference points. Conversely, objects may be a set of raw samples that are matched directly with corresponding raw samples stored in the map.

At the heart of the navigation logic is a vehicle position determination logic 170. In accordance with an embodiment, the vehicle position determination logic receives input from each of the sensors, and other components, to calculate an accurate position (and bearing if desired) for the vehicle, relative to the digital map, other vehicles, and other objects.

A vehicle feedback interface 174 receives the information about the position of the vehicle. This information can be used by the driver, or automatically by the vehicle. In accordance with an embodiment, the information can be used for driver feedback 180 (in which case it can also be fed to a driver's navigation display 178). This information can include position feedback, detailed route guidance, and collision warnings. In accordance with an embodiment, the information can also be used for automatic vehicle feedback 182. This information can include some functions of automatic vehicle driving or piloting such as brake control, and automatic vehicle collision avoidance.

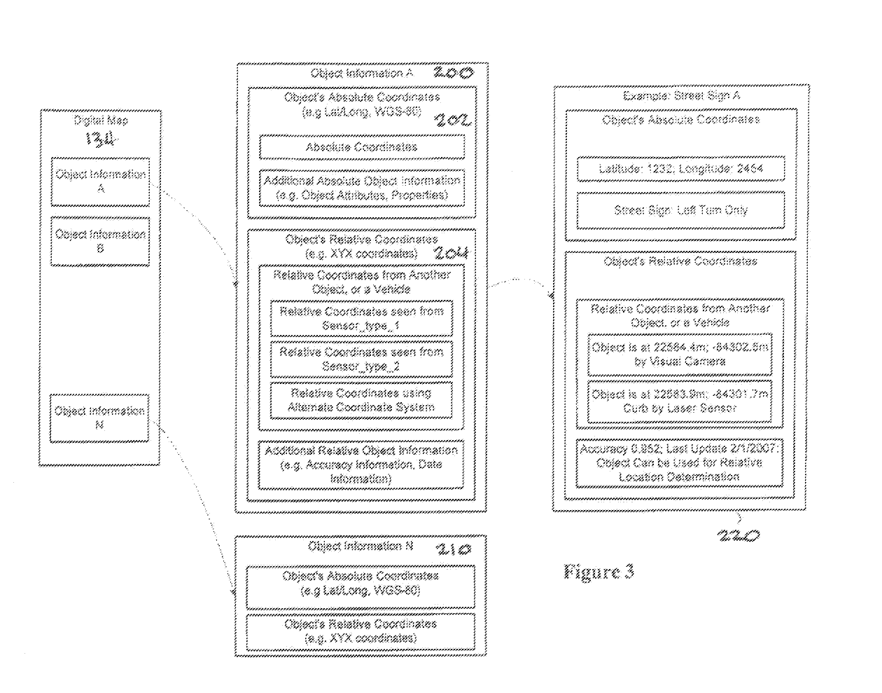

FIG. 3 shows an illustration of a digital map 134, or a database of map information, including absolute and relative coordinates, in accordance with an embodiment of the invention. FIG. 3 illustrates one example of the type of digital map format that can be used. The digital map illustrated in FIG. 3 has been simplified for purposes of explanation. It will be evident that additional modifications to the map and the map format, including additional fields, may be made within the spirit and scope of the invention. Novel features of the digital map may also be incorporated into, or combined with, existing digital maps and map databases, such as those provided by Tele Atlas, examples of which are described in copending U.S. patent applications titled “SYSTEM AND METHOD FOR ASSOCIATING TEXT AND GRAPHICAL VIEWS OF MAP INFORMATION”; application Ser. No. 11/466,034, filed Aug. 21, 2006 (TELA-07743US2); and “A METHOD AND SYSTEM FOR CREATING UNIVERSAL LOCATION REFERENCING OBJECTS”; application Ser. No. 11/271,436, filed Nov. 10, 2005, both of which applications are incorporated herein by reference. As shown in FIG. 3, the digital map or database comprises a plurality of object information, corresponding to a plurality of objects in the real world that may be represented on a map. Some objects, such as the unpainted centerline of a road as described above, may not be real in the sense they are physical, but nevertheless they can still be represented as objects in the digital map. FIG. 3 represents three objects, including Object A, B through N, together with the information associated therewith. It will be evident that a typical digital map might contain millions of such objects, each with their own unique object identifier. Examples of the object identifier that can be used include the ULRO feature described in the patent application titled “A METHOD AND SYSTEM FOR CREATING UNIVERSAL LOCATION REFERENCING OBJECTS”, referenced above.

In accordance with an embodiment, some (or all) of the plurality of objects 200 includes one of absolute 202 and/or relative 204 coordinates. In any digital map some of the map objects may not have an actual physical location, and are only stored in the digital map by virtue of being associated with another (physical) object. Furthermore the map can include many non-navigation attributes. Of more importance to the present context are those map objects that do indeed have a known physical location, and which can be used for relative position functions. In accordance with an embodiment, these objects, such as Object A, have both an absolute coordinate, and a relative coordinate.

The absolute coordinate can comprise any absolute coordinate system, such as simple latitude-longitude (lat-long), and provides an absolute location of the object. The absolute coordinate can have additional information associated therewith, including for example, the object's attributes, or other properties.

The relative coordinate can comprise any relative coordinate system, such as Cartesian (x,y,z), or polar coordinates, and provides a relative location of the object. The relative coordinate can also have additional information associated therewith, including for example, the accuracy associated with that object record, or the last date the record was updated. In accordance with an embodiment, the relative coordinate also includes an accurate relative position of the object to another object or to an arbitrary origin. It is convenient to express the relative coordinates in terms of an arbitrary origin because all of the relative positions can then be measured by taking the difference of one coordinate set from another and in that process, the arbitrary origin cancels out. In accordance with an embodiment, the relative coordinate for a particular object can indicate multiple relative position information to represent how the object may be seen using multiple different types of sensors, or using different relative coordinate systems.

Each additional object N 210 in the digital map can have the same type of data stored therewith. Some objects (for example a building, minor signs) may not have the same benefit with regard to relative positioning, and may include only absolute positioning coordinates, whereas more important objects (such as street corners, major signs), that are relative-position enabled, should include both absolute positioning and relative positioning coordinates. Some larger objects may have more information describing particular aspects of the object (e.g. the north-west edge of a building), that in turn provides the appropriate precision and accuracy.

Synchronization with Absolute Measurements

As described above, an embodiment of the system provides a linkage between the absolute location or coordinates of an object in an absolute coordinate system, and the relative location or coordinates of the same object in a relative coordinate system, by virtue of a common object identifier (ID), such as a ULRO. In this manner there is no need for a tight mathematical linkage between the two coordinate systems. Indeed such a linkage would reduce the benefits of the system because the relative coordinates will be very accurate with respect to objects nearby, but will accumulate random errors when measured relative to objects further away. This will have the effect that if one arbitrarily equated the relative position at a point to its absolute position then at large inter-object distance (say more than 10 kilometers away) the relative position would appear to have large errors in comparison with its absolute coordinates.

In practical use, care can be taken to synchronize absolute and relative measurements over time to make for ever-increasing accuracy, but this is not necessary to practice the invention and indeed adds considerable expense. Similarly, absolute measurements can be taken to high accuracy (i.e. sub-meter level accuracy), within a relatively closely spaced grid and compared to the relative positions of all nearby objects. An error minimizing technique can then be used to rubber sheet all points to an absolute grid. While this eliminates the need for the second (relative) set of coordinates to be carried in the database, it requires the additional cost of collecting survey points, processing them, and the time and expense of resolving countless situations where the group of points within an area are sufficiently inconsistent that rubber sheeting will not bring all points into the relative accuracy specification.

### Relative Coordinate System

As described above, the relative position of an object can be stored in the database in an number of different ways, including for example Cartesian, or polar coordinates. Because relative coordinates are provided to solve inherently local problems almost any coordinate system can be made to work in that locality. In accordance with an embodiment, State planar coordinates are well suited. Numbers can be represented modulo some large number, because the absolute number does not matter, and selecting a specific origin is not important. This is again because the act of making the relative measurements involves differencing the coordinates, and the origin cancels out. However, what can be important is the ability of the system to indicate a change of coordinate systems. For example, if a different system is used in Canada than in the United States (e.g. Canada uses decimal meter distances, while the US uses decimal feet, each with its own origin (x,y) point) then the data stored for each object, particularly in U.S./Canadian border regions, must include information that a transition is occurring, and which relative coordinate system should be used. This is due to the fact that, if you difference measurements taken from two different coordinate systems then the origin would not cancel, and the differences in scales would also introduce errors.

In accordance with an embodiment, other flags or indications can be incorporated into the data to indicate possible relative errors. For example, data can be collected from mobile mapping vans, which traverse roads, and collect data as they go. Each van might collect a certain territory on a certain day. Another van may collect an adjacent territory at a different day and time. Care should be taken by the mapping vendors to overlap these two areas so that a single set of relative coordinates for objects in the map can be derived. However, if there are gaps, or if other reasons mean that relative accuracy cannot be preserved, then the database records can contain a flag or indication that objects past a certain point are not accurate relative to the objects before that point, and that the navigation device should reset its relative coordinate system once it finds objects again marked as relatively accurate.

It will be noted that such gaps might be directional in nature or even road-specific. For example, a single relative system may be developed for a highway, but a different system may be developed for the surface streets surrounding that highway.

### Relative Navigation Method

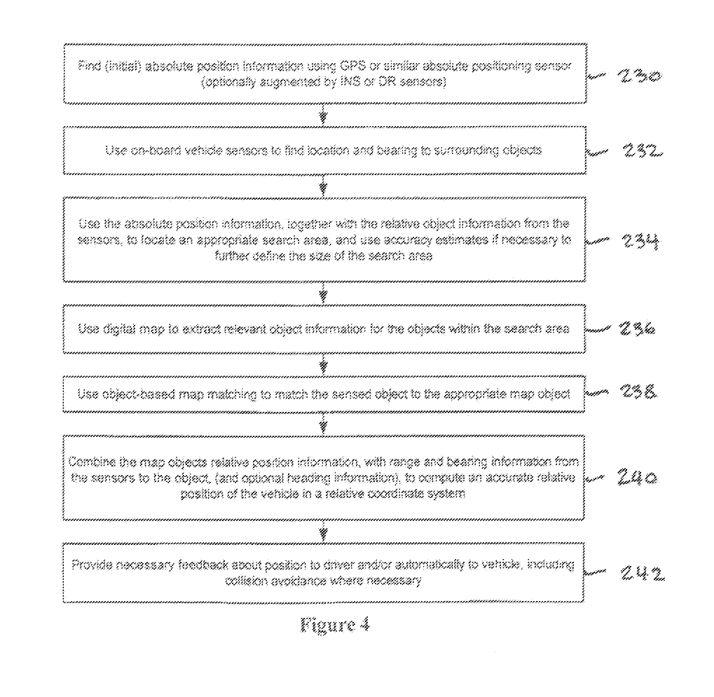

FIG. 4 shows a flowchart of a method for navigating using absolute and relative coordinates, in accordance with an embodiment of the invention. As shown in FIG. 4, in a first step 230, the vehicle navigation system determines an (initial) absolute position for the vehicle, using GPS, Galileo, or a similar absolute positioning receiver or system. This initial step may also optionally include combining or using information from INS or DR sensors. In the following step 232, the system uses on-board vehicle sensors to find the location of, and bearing to, surrounding objects. In step 234, the system then uses its knowledge of the vehicle's current absolute position to access objects in the digital map (or map database) that are within an appropriate search area, based on the estimate of the absolute accuracy of the vehicle and the map. In accordance with some embodiments the search area can be centered on the estimated current position of the vehicle. In accordance with other embodiments, the search area can be centered on an actual or estimated position of one of the objects. Other embodiments can use alternative means of centering the search area, including, for example, basing the search area on estimated look-ahead position reading from the sensors. Using the relative positions of the sensed objects, (together with optionally one or more of their measured characteristics, e.g. size, height, color, shape, categorization etc), the system, in steps 236 and 238, uses object-based map matching (“object matches”) the sensed information with the objects in the search area to uniquely identify the sensed objects and extract relevant object information. In step 240, the relevant object information, and the relative positions of those objects, (together with optional heading information), allows the vehicle navigation system to calculate an accurate relative position for the vehicle within a relative coordinate space, or relative coordinate system. In step 242, this accurate position is then used by the system to place the vehicle in a more accurate position relative to nearby objects, and alternatively to provide necessary feedback about the position to the driver, or to the vehicle itself, including where necessary providing assisted piloting, collision avoidance warning, or other assistance.

In accordance with some embodiments, the absolute position information and the relative position information can also be combined to calculate an accurate absolute position for the vehicle. This accurate position can again be used by the system to place the vehicle in a more accurate position within a relative coordinate system, provide feedback about the position to the driver, or to the vehicle itself, including collision avoidance warning, piloting or other assistance. A more accurate absolute position can also be used to reduce the search area size for subsequent object-based map matching.

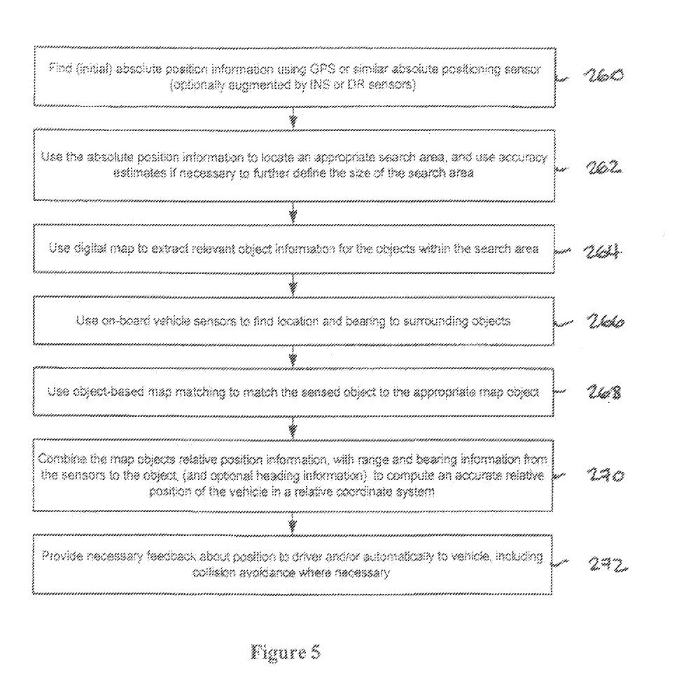

FIG. 5 shows a flowchart of an alternative method for navigating using absolute and relative coordinates, in accordance with an embodiment of the invention. As shown in FIG. 5, in a first step 260, the vehicle navigation system again determines an (initial) absolute position for the vehicle, using GPS, Galileo, or a similar absolute positioning receiver or system. In step 262, the system then uses a focus generator to determine a search area around this initial position. As with the above example, depending on the particular implementation the search area can be centered on the estimated current position of the vehicle, or on an actual or estimated position of one of the objects, or using some alternative means. In the following step 264, the system uses the digital map (or map database) to extract object information for those objects in the search area. The system then, in step 266, uses its on-board vehicle sensors to find the location of, and bearing to, those objects. Using the relative positions of the sensed objects, (together with optionally one or more of their measured characteristics, e.g. size, height, color, shape, categorization etc), the system, in step 268, uses object-based map matching to match the sensed information with the objects in the search area. In step 270, the relevant object information, and the relative positions of those objects, allows the vehicle navigation system to calculate an accurate relative position for the vehicle within a relative coordinate space, or relative coordinate system. As with the previous technique, this accurate position is then used by the system, in step 272, to place the vehicle in a more accurate position within the relative coordinate system, and alternatively to provide necessary feedback about the position to the driver, or to the vehicle itself, including where necessary providing collision avoidance assistance.

In accordance with an embodiment, the system allows some objects to be attributed using relative positioning, without recourse to storing absolute position information. Using this approach, a first object may lack any stored absolute position information, whereas a second object may have absolute position information. The system computes a position for the first object that is measured relative to the second object (or using a series of relative hops through third, fourth, etc. objects). The second object must be either explicitly pointed-to by the first object, or alternatively must be found as part of the network of objects surrounding the first object. The relative position information can then be used to provide an estimate of the absolute position of the first object.

For example, the centerline of a road can be attributed with absolute coordinates. Each lane of the road can then be attributed with a relative offset coordinate to the centerline. Since in many instances the relative positions can be measured more precisely than the absolute positions, this technique can provide a reasonably accurate estimate of an object's absolute position, so long as the distance (or the number of relative hops) from the object being measured to the object with the absolute measurement is not too far that it diminishes overall accuracy. An advantage of this technique is that it requires much less data storage while still being able to provide accurate absolute object position information.

Driving Environment with Relative Positioning

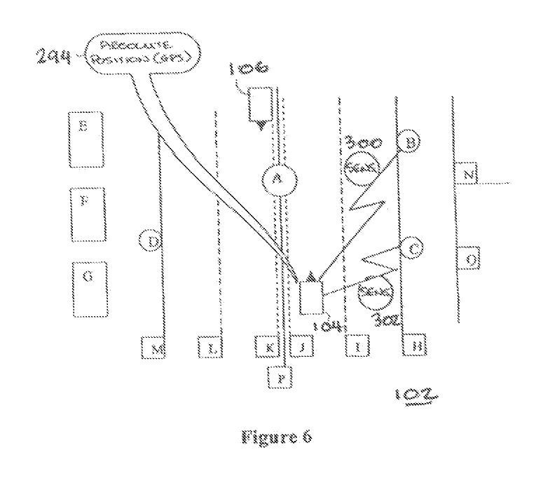

FIG. 6 shows a more-detailed illustration of an environment that uses a vehicle navigation system and method, in accordance with an embodiment of the invention. FIG. 6 illustrates the street scene previously shown in FIG. 1, together with cars, lanes, road signs, objects and buildings. Again, labels 1, J, K and L identify individual painted lines and other objects that might be found on the street. The solid line labeled P represents the single centerline representation of the road. Lines J and K represent the double-yellow marking or lines that one might find in the middle of a road. Lines I and L represent lane dividers, while lines H and M represent the street curbs. Labels E, F, G, N and O represent buildings; and labels A, B, C, and D represent street signs or notices, such as speed signs, stop signs, and street name signs.

As shown in FIG. 6, label 104 representing a first vehicle (i.e. a car) incorporates a vehicle navigation system in accordance with an embodiment of the invention. As the vehicle moves, the navigation systems determines an absolute position 294 for the vehicle, using for example GPS. Sensors on the vehicle determine 300, 302 distance and bearing to one or more objects, for example street signs B and C. Information for all objects in a search area defined by the estimated accuracy of the map and the current absolute position determination are retrieved. For example, if the search area includes all of the objects A-O, then it's possible that object-based map matching will uniquely identify B and C from all the objects by virtue of the sensed characteristics of these objects and by virtue of the relative distance and bearing between these two objects. Only objects B and C may exhibit this match with high probability, so the detailed information for each of these objects is retrieved from the digital map. The combined information is then used by the vehicle's navigation system to determine an accurate position for the vehicle with regard to the road, the street furniture (curbs, signs, etc.) and optionally other vehicles (when the navigation systems in those vehicles include communication means). The accurate position information can then be used for improved vehicle navigation, guidance and collision warnings and avoidance.

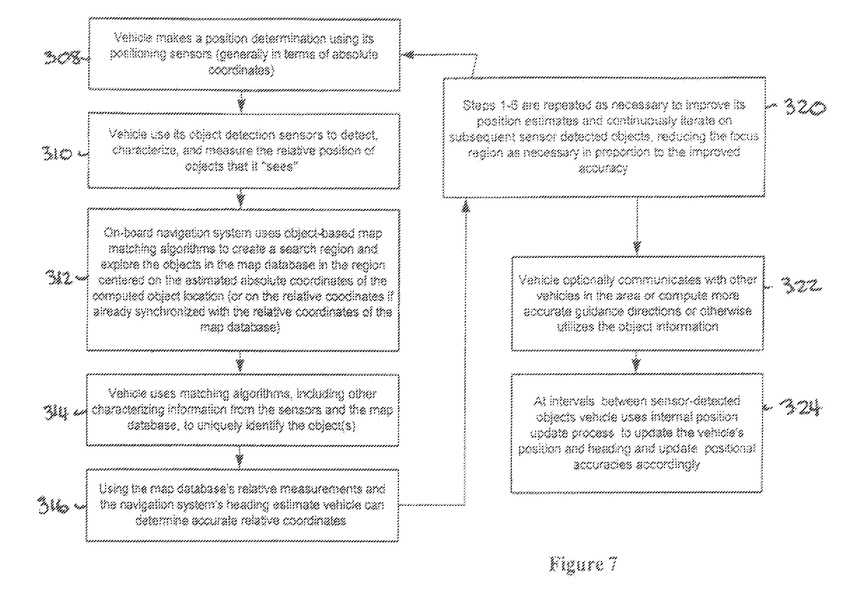

FIG. 7 shows another flowchart of a method for navigating using absolute and relative coordinates, in accordance with an embodiment of the invention. FIG. 7 also illustrates how absolute position information and relative position information can be combined to calculate an accurate absolute position for the vehicle. This accurate position can again be used by the system to place the vehicle in a more accurate position within a relative coordinate system. A more accurate absolute position can also be used to reduce the search area size for subsequent object-based map matching. As shown in FIG. 7, in a first step 308, the system makes a position determination using its positioning sensors (generally in terms of absolute coordinates). In step 310, the vehicle then uses its object detection sensors to detect, characterize, and measure the relative position of objects that it “sees”. In the next step 312, the system uses map-object-matching algorithms to explore the objects in the map database in the search area or region centered on the estimated absolute coordinates of the computed object location (or on the relative coordinates if it had synchronized with the relative coordinates of the map database at some relatively nearby position). In accordance with an embodiment, the search region size is roughly proportional to the combined error estimates of the absolute coordinates of the map objects and the vehicle's position determination (or the combined error estimates of the relative coordinates of the map objects and the vehicles relative position determination). Using this technique, the relative accuracy is more accurate nearer to an object, and is less accurate further away from the object. For example, if the last time that the vehicle had synced with objects was 50 miles ago, then using relative positions to ascertain the vehicle position would probably not be satisfactory. However, under normal driving circumstances, a driver would be driving in a relatively rich environment of objects and their vehicle would “see” objects almost continuously, or every few meters. In this environment and under these conditions, the relative positions can be made very accurate, even more so than the absolute accuracies.

In step 314, using its matching algorithms, including other characterizing information from the sensor and the map database, the system can then uniquely identify the object or objects “seen”. In step 316, using the object's or objects' relative measurements from the map database and if needed the navigation system's own DR or INS heading estimate, the vehicle can determine its accurate relative coordinates. For example, if only one object is matched, and if the vehicle has a measurement of distance to the object and a relative bearing, then the navigation system can only define its location along a locus of points that is a circle, with the object at the center of the circle and a radius equal to the distance measured. In theory, a vehicle can travel along that radius while keeping the same bearing to the object; thus with distance and bearing alone one cannot uniquely determine the exact point along that locus that pinpoints the vehicle. In these situations, the estimated heading of the vehicle can be used in combination with the relative measurements. Since there is only one point on the locus of points where the vehicle has that heading, a unique point can be determined. Generally, heading estimates are not the most accurate so this technique could add a certain amount of inaccuracy in the relative position. To address this, two or more objects can be sensed simultaneously or in very close sequence (i.e. within a distance that the vehicles heading relative heading has not accumulated much error). A circle (locus of points) can be drawn from both objects with appropriate radii, and the bearings to the two objects used to determine which of the two points is physically the correct point. Thus a more accurate relative position can be calculated for the vehicle.

It will be evident that the above calculations are just one example of the type of relative calculation with a single or multiple objects that can be used with various embodiments of the invention, and that other calculations and data combinations may be used within the spirit and scope of the invention to help determine the position of the vehicle from sensor measurements.

In accordance with an embodiment, the vehicle can, in step 322, use its relative coordinates to communicate with other vehicles in the area, or compute more accurate guidance directions or utilize the object information. The results of the preceding steps can then be repeated as necessary (indicated by step 320) to improve the position estimate and continuously iterate on subsequent sensor detected objects, reducing the search region in proportion to the improved accuracy based on this process. At intervals between sensor-detected objects the vehicle can, in step 324, use its internal position update process to update the vehicle's position and heading and update an estimate of the positional accuracies accordingly. If the vehicle travels too far without such updates, its relative accuracy will deteriorate, and it will again need to rely on its absolute positioning to start the sequence all over again.

In another embodiment, additional highly accurate absolute position measurements can be made throughout an area. The relative positions of objects can be collected as described. Then a process can be conducted to “rubber sheet” all points according to error minimizing schemes which are well known by those skilled in the art and those points not falling within accuracy specifications can be reviewed and the process reiterated as needed. This can eliminate the need of carrying two sets of coordinates (one absolute and another relative) but it adds extra work and extra costs.

### Object-Based Map Matching

It will be noted that the type of map matching described with respect to embodiments of the present invention is inherently different from and more accurate than traditional map matching techniques. In the case of traditional map matching, such as used with dead-reckoning, the sensors on board the vehicle only estimate the vehicle position and heading, and have no direct sensor measurement of the existence or position of any object such as a road or a physical object along side the road. Also, with traditional map matching the map is a simplified representation of the road, only containing the theoretical concept of the “center” of the road, so the map matching is performed on an inference basis, i.e. the algorithms infer that the car is likely on the road and can then be approximated as being on the centerline of the road. In contrast, in the object-based map matching used with the present invention a sensor detects the existence of one or more objects and possibly additional identifying characteristics (such as color or size or shape or height of a sign, or receives some information about the RFID associated with the object) and also measures its position and uses this information to match to objects of similar characteristics and location in the map database. Additionally, unlike traditional map matching which matches a vehicle to a two dimensional road and thus only has enough information to improve the accuracy in one degree of freedom, the map matching of the present invention can also be used with point objects, and therefore has the ability to improve the accuracy in two degrees of freedom. Thus the sensor-detected object matching of the present invention can be more accurate and more robust than previous forms of map matching.

Even though embodiments of the present invention utilize map matching techniques to help minimize errors; as with any map matching technique the risk of error still exists, namely the possibility of matching to the wrong object in the database. If the sensor senses one or more road signs, in an area of many road signs, there exists a possibility that the object-based map matching algorithm will match to the wrong sign and hence introduce an error to the estimated relative position of the vehicle. However, embodiments of the invention can include additional features and techniques to further reduce that risk.

First, the risk of error is greatly reduced by the facts given above, namely that the sensor is sensing a real object and hence object-based matching does not simply need to infer the existence of an object. Second, as described above the objects have distinguishing characteristics. Third, map vendors can collect a generally high density of objects with different characteristics so that multi-object map matching or rapid sequential object-based map matching can be used to disambiguate the situation (for example detecting two signs that are observed to be signs and accurately measured to be 3.43 meters separated at can make the matching process much more robust than simply trying to match a single object. It is also recommended that filtering means based on many detected and matched objects and generally well known in the navigation art be used to limit the potential influence of any single error. A fifth and very useful aspect of the present invention is that once an initial object match has been performed using the absolute positional information of the navigation device, the device can compute a relative estimate of position and use that to improve the center of the search area and further limit the size of the search area. From this point forward, the map matching can be done based on relative accuracies and the search areas can be dramatically reduced, making the possibility of erroneous matches diminishingly small. It should be noted, again, that this sequential process remains good as long as object-based matches continue to eliminate the accumulation of error that will naturally occur when using the systems INS or DR sensors.

### Sensor Collection and Accuracy

Embodiments of the present invention are practical to implement, because it is cheaper to measure the relative positions of objects at a given accuracy than it is to measure the absolute positions at the same accuracy, and it is cheaper for a vehicle to only need to measure absolute position to a lower accuracy that would be needed in these high relative accuracy applications. The addition of additional sensors to vehicles adds only minimal cost; such sensors are already being proposed by the automotive industry to give the driver additional useful information about navigation and objects, and furthermore such sensors are still cheaper than the additional hardware that would be needed to reliably improve the accuracy of absolute vehicle measurements. As described above, inertial navigation units are available with 20 centimeter accuracy over 100 meters. Mobile Mapping Platforms can collect camera, laser scanner and radar data as the vehicle drives down a street. The data is collected in synchronicity with the collection of position and heading data from an on-board GPS/INS systems, examples of which are described in copending PCT applications titled “ARRANGEMENT FOR AND METHOD OF TWO DIMENSIONAL AND THREE DIMENSIONAL PRECISION LOCATION AND ORIENTATION DETERMINATION”; Application No. PCT2006/000552, filed Nov. 11, 2006; “METHOD AND APPARATUS FOR DETECTION AND POSITION DETERMINATION OF PLANAR OBJECTS IN IMAGES”; Application No. PCT/NL2006/050264, filed Nov. 3, 2006; and “METHOD AND APPARATUS FOR DETECTING OBJECTS FROM TERRESTRIAL BASED MOBILE MAPPING DATA”; Application No. PCT/NL2006/050269, filed Oct. 30, 2006, each of which are incorporated herein by reference. In many instances two objects may be in the same image and their relative positions can be precisely determined. In other cases the next object may be only a few meters further down the road, and the INS system will accumulate only millimeters of errors across that distance. Also modern Object Detection/Extraction algorithms can efficiently detect and measure the objects sensed by the sensors such as cameras. Aerial and satellite photography can also be used to measure the relative positions of objects without the need to form the absolute measurements at the same level of accuracy.

Driving Environment with Accurate Lane Positioning

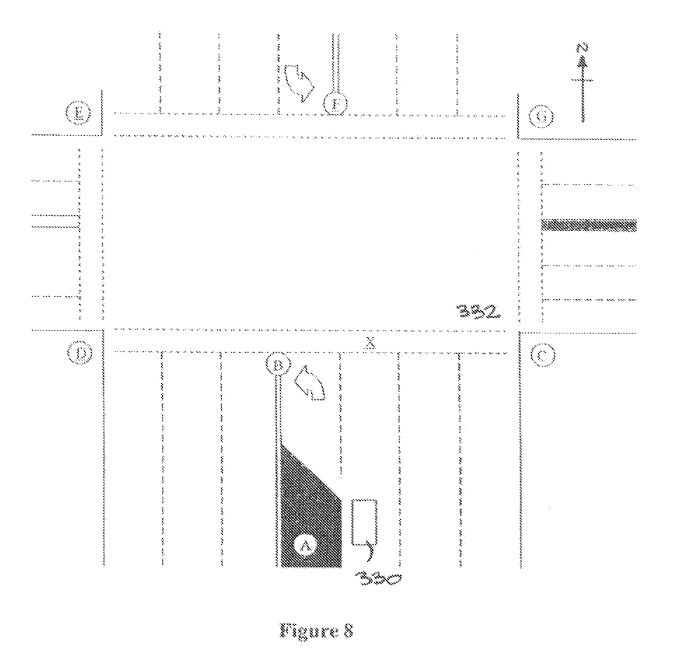

FIGS. 8-10 show an illustration of an environment that can use vehicle navigation to discern lane positioning, in accordance with an embodiment of the invention.

As shown in FIG. 8, a car 330 is traveling northbound and approaching an intersection 332. As shown in FIG. 8, the vehicle is approaching an intersection, and the vehicle's navigation system has computed a path (not shown) to its destination that suggests making a left turn at the intersection.

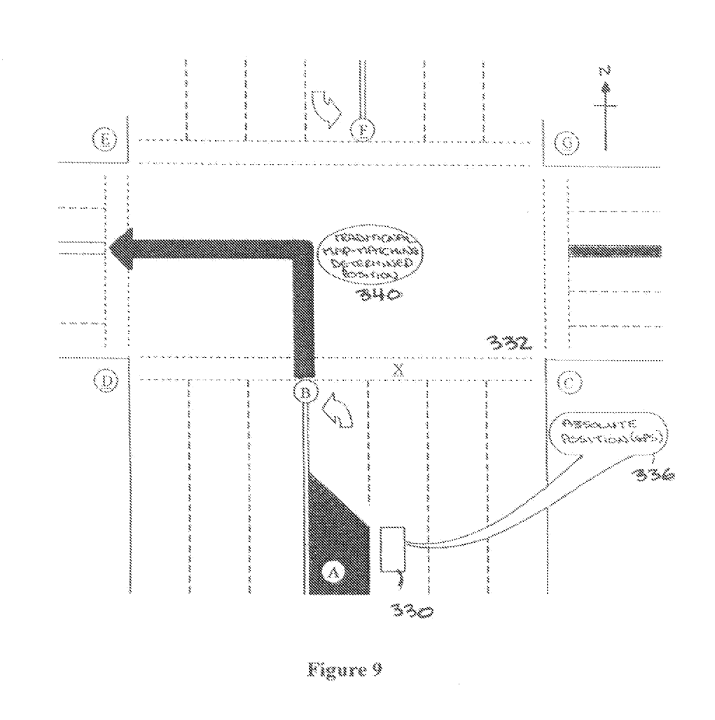

In a traditional navigation system, or one which does not utilize absolute and relative position sensing for accurate position determination, the map would likely only show a single centerline for each of the segments connected at the center of the intersection. Thus, as shown in FIG. 9, the guidance provided to the vehicle would be a simple highlighted path 340 with a 90 degree turn at the point of intersection between the two streets.

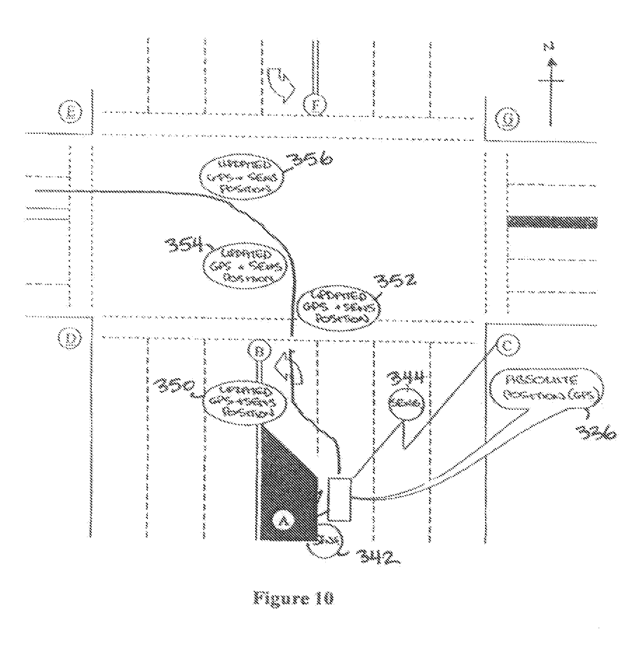

In accordance with an embodiment of the present invention, illustrated in FIG. 10, the system (and thus the digital map) “knows” the lane information in much greater detail. In the example illustrated in FIG. 10, the car is equipped with a sensor, for example a radar sensor. The radar sensor can detect 342, 344 and measure the distance and heading to some of the various objects near it, for example the traffic light posts and traffic signs and signposts labeled A, B, C, D. E, F, and G. The map in the navigation/guidance and safety system thus contains information about these objects. The digital map can include the absolute position and relative position of the objects, together with other information such as an RFID tag information if it were present, accuracy limits and type and class of object. The car can then use its absolute position estimate 336 and the relative distance and headings to these objects (and possibly previous information about its relative positions computed from previous observations of objects) to object-based map match to the group of objects that it can see. On the basis of this matching and the relative measurements, the navigation system can accurately compute its position relative to these objects contained on the map.

Once the in-car navigation system has computed its position in the relative coordinate space defined by the map, the system can then compute its position relative to the other objects contained in the map that the radar sensor could not detect. So for example, the navigation system can compute what lane the car is in, and accurately compute when it gets to the point on the road that the left turn lane begins. The system can then tell the driver that he can enter the left turn lane (perhaps confirming first by the radar measurements that the left turn lane is not occupied). In a more general setting the system can tell the driver if he/she is drifting out of their current lane. As the vehicle moves, the navigation system computes both an updated absolute position and an updated relative position 350. In accordance with an embodiment It can do this by recomputing its position by updating its radar measurements, or by using dead reckoning, or an update to its absolute sensor, or a combination of some or all the above to best refine its relative measurement 352, 354, 356. As it approaches the cross walk, X, it can then accurately determine how close it is to it, based on the relative measurements of the map and its updated relative position. If the car is slowing down, the navigation system can sense, for example, that the car needs to stop, and can assist the driver in coming to an accurate stop just before the crosswalk. Such a system can be used at even further distances to assist drivers in coming to fuel efficient and comfortable stops for red lights etc, especially with the added information from road infrastructure regarding traffic light timing. The system can then continue to inform the driver as to how to navigate the car through the intersection and into the appropriate westbound lane.

While there are many other safety considerations to be factored into automatic driving controls, the accuracy of a relative system such as that of the current invention can help address the issue of position accuracy, and its use in assisted driving.

### Additional Applications—Maneuver Support

It will be noted that the invention has been primarily described in the context of collision warning and avoidance. However, this is only one of many applications of this combined absolute and relative navigation system. For example, the location of a road intersection can be accurately determined as a distance from the last identified sign, so that more accurate turn indications can be given. As another example, the accurate location of the vehicle laterally (with respect to lanes) can be determined to give guidance on which lane to be in, perhaps for an upcoming maneuver or because of traffic, or road construction. It will be evident that the navigation system described herein may be used in a wide variety of automatic and assisted driving, vehicle piloting, collision avoidance, and other warning systems and driving assistance devices.

### Additional Applications—Extension to 2D and 3D

It will be noted that the above examples have been presented primarily using point objects such as signs. Other important objects exist and can be readily detected. These can eventually be made part of more advanced map databases. For example, lane strips can be detected by some sensors (e.g. cameras and laser scanners). Hence an accurate position with respect to this lane object can be computed in the very important dimension associated with lane keeping. Such information is partial in nature; for example, knowing that the lane stripe is 10 centimeters from the left bumper can accurately determine one coordinate but tells little about the second (along the road) coordinate. Care must also be taken to avoid ambiguities regarding which lane is detected. Algorithms that combine such information derived from two-dimensional (2D) objects with information derived from even occasional one-dimensional (1D) objects and their own navigation system will be able to maintain their accurate relative positioning. The relative coordinate information attributed to such a 2D object is not a relative x,y position but rather an equation defining its linear characteristic in relative x,y coordinate space. Similar considerations hold true of three-dimensional (3D) objects such as buildings. In this case care should also be taken to identify more specific objects or characteristics, such as the edge of the building.

### Additional Applications—Continuous Processing

While the present invention can be implemented in many ways, in some embodiments the system is intended to be used in a continuous manner. In accordance with this embodiment, the navigation system may detect a first object and compute a relative position based on the object's relative position attributes and the vehicle's object sensor/relative measurement device and its estimated heading. The navigation system can then measure a second object in the same way as quickly as its on-board equipment and the map and the density of objects would permit. Continuous relative measurements can also be fed back to improve the current estimate of the vehicle's absolute position and heading.

The present invention may be conveniently implemented using a conventional general purpose or a specialized digital computer or microprocessor programmed according to the teachings of the present disclosure, as will be apparent to those skilled in the computer art. Appropriate software coding can readily be prepared by skilled programmers based on the teachings of the present disclosure, as will be apparent to those skilled in the software art. The selection and programming of suitable sensors for use with the navigation system can also readily be prepared by those skilled in the art. The invention may also be implemented by the preparation of application specific integrated circuits, sensors, and electronics, or by interconnecting an appropriate network of conventional component circuits, as will be readily apparent to those skilled in the art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD ROMs, microdrive, and magneto optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, while the invention has been primarily described in the context of collision warning/avoidance, this is just one of many applications of this combined absolute and relative navigation system. For example, the location of a road intersection and its cross walks can be accurately determined as a distance from identified signs, so more accurate turn indications can be given or cross walk warnings given; or the location of the vehicle lateral to a road (with respect to lanes) can be accurately determined to give guidance on which lane to be in, perhaps for an upcoming maneuver, or because of traffic. Different embodiments can use different forms of absolute position sensing, for example by allowing the operator of a vehicle to manually define an initial absolute vehicle position; or by using the location of a sensed RFID tag, perhaps in combination with other measurements, to automatically determine an initial absolute vehicle position that corresponds to that RFID tag. Other embodiments can utilize or combine the techniques described herein with map-matching techniques such as those described at the outset, to provide an overall more accurate system for position determination. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for vehicle navigation using absolute and relative coordinates comprising:
a map database that contains information for a plurality of objects, including the absolute geographic location and relative spatial location of the objects;
an absolute position sensor that is used by the system to determine an initial absolute geographic position of the vehicle;
one or more sensors can determine the existence and relative bearing of physical objects in the vicinity of the vehicle, that are also referenced as corresponding objects in the map database; and
a navigation logic that uses absolute geographic position of the vehicle to determine which of the plurality of objects in the map database should be selected, and then uses the spatial coordinate of the selected objects, together with the relative bearing of those physical objects to the vehicle, to determine an accurate vehicle position, for use in vehicle navigation.

2. The system of claim 1, wherein the system further comprises an object matching algorithm that determines the position of sensed objects by virtue of its determined position and the range and bearing to the object and then uses the determined position together with sensed characteristics of the object to search the map database and match the sensed object to the appropriate object in the map database.

3. The system of claim 2, wherein the system can extract information about the matched object in the database for use by the vehicle.

4. The system of claim 1, wherein the system extract information about objects in the map database that its on-board sensors are not able detect and provides information about those objects to the vehicle.

5. The system of claim 1, wherein the system extracts a set of coordinates of the object based on the known range and bearing to the object and the estimated heading of the vehicle, to compute an accurate relative location and heading of said vehicle.

6. The system of claim 1, wherein the system uses the accurate position as inputs to collision warning/avoidance and route guidance applications.

7. The system of claim 6, wherein the system can communicate with other vehicles to obtain the relative position and heading estimates from other vehicles to compute possible collisions.

8. The system of claim 7, wherein the communications and computations may be done off-board by some central server or by some series of off-board distributed servers.

9. The system of claim 1, wherein the physical objects include RFID or other identifiers.

10. The system of claim 9, wherein the physical objects include any of street signs and road markings.

11. A method for vehicle navigation using absolute and relative coordinates comprising the steps of:
accessing a map database that contains information for a plurality of objects, including the absolute geographic location and relative spatial location of the objects;
using an absolute position sensor to determine an initial absolute geographic position of the vehicle;
using one or more sensors to determine the existence and relative bearing of physical objects in the vicinity of the vehicle, that are also referenced as corresponding objects in the map database; and
using the absolute geographic position of the vehicle to determine which of the plurality of objects in the map database should be selected, and then using the spatial coordinate of the selected objects, together with the relative bearing of those physical objects to the vehicle, to determine an accurate vehicle position, for use in vehicle navigation.

12. The method of claim 11, wherein the system further comprises an object matching algorithm that determines the position of sensed objects by virtue of its determined position and the range and bearing to the object and then uses the determined position together with sensed characteristics of the object to search the map database and match the sensed object to the appropriate object in the map database.

13. The method of claim 12, wherein the system can extract information about the matched object in the database for use by the vehicle.

14. The method of claim 11, wherein the system extract information about objects in the map database that its on-board sensors are not able detect and provides information about those objects to the vehicle.

15. The method of claim 11, wherein the system extracts a set of coordinates of the object based on the known range and bearing to the object and the estimated heading of the vehicle, to compute an accurate relative location and heading of said vehicle.

16. The method of claim 11, wherein the system uses the accurate position as inputs to collision warning/avoidance and route guidance applications.

17. The method of claim 16, wherein the system can communicate with other vehicles to obtain the relative position and heading estimates from other vehicles to compute possible collisions.

18. The method of claim 17, wherein the communications and computations may be done off-board by some central server or by some series of off-board distributed servers.

19. The method of claim 11, wherein the physical objects include RFID or other identifiers.

20. The method of claim 19, wherein the physical objects include any of street signs and road markings.

21. A map database for use in vehicle navigation using absolute and relative coordinates comprising:
a plurality of object records corresponding to a real world environment, including streets and objects within, for use in conjunction with a land navigation and/or collision avoidance device used in vehicles, and wherein each of the plurality of object records further comprises
a first set or sets of coordinates defining on the surface of the earth the absolute location of the object in any appropriate coordinate reference system, and
a second set or sets of coordinates defining on the surface of the earth the relative location of at least one of said objects in said database in any appropriate coordinate reference system, and which can be compared to a sensor reading of the same object from a sensor on the vehicle; and
whereby said first coordinates and said second coordinates are linked by attribution to the same map object, and can be used together to determine an accurate position for the vehicle.

22. The map database of claim 21 wherein said map objects have attributes identifying them as relative positionally accurate in relation to specified other objects.

23. The map database of claim 21 wherein said map objects have attributes identifying the accuracy level.

24. The map database of claim 21 wherein said map objects have attributes identifying that they are at or near a transition between different sets of relationally accurate data or at a boundary between relationally accurate data and no relationally accurate data.

25. The map database of claim 21 wherein said map objects are attributed with characteristics that help identify it by sensor data.

26. The map database of claim 25 wherein said map objects characteristics may be different for different sensors.

27. The map database of claim 25 wherein said second set of coordinates may be more than one set of coordinates depending upon the type of sensor that is sensing the object.

28. The map database of claim 21 wherein said second set of coordinates are any coordinates able to express relative coordinates.

29. The map database of claim 28 wherein said relative coordinates might be state plane coordinates.

30. The map database of claim 28 wherein said relative coordinates might be simple planar coordinates.
